(19) United States
(12) Patent Application Publication
(10) Pub. No.: US 2002/0052182 A1
(43) Pub. Date: May 2, 2002

(54) Input apparatus and device, method for controlling the same, and storage medium storing a program for executing the method

(76) Inventor: Ichiko Mayuzumi, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/981,818

(22) Filed: Oct. 19, 2001

(30) Foreign Application Priority Data
Oct. 30, 2000 (JP) 330839/2000
Oct. 1, 2001 (JP) 305109/2001

(51) Int. Cl. H04B 5/00

(52) U.S. Cl. 455/41; 455/500

(57) ABSTRACT

A summary of devices which can be operated by an input apparatus is displayed on a display unit of the input apparatus. Thus, the user can easily select a device to be operated through the input apparatus. Radio connection between the input apparatus and other devices that are not operated by the input apparatus is not disconnected, but the radio connection is continued in a low-power-consumption mode. Since the input apparatus and the other devices perform only minimum transmission/reception processing, power consumption and the amount of communication processing can be reduced. Furthermore, since it is unnecessary to newly perform a procedure for providing radio connection when the device to be operated is changed, switching of the device can be smoothly performed.

### BACKGROUND OF THE INVENTION

1. Field of the Invention

The present invention relates to an input apparatus and device for performing operations for a plurality of devices, a method for controlling the same, a program for executing the method, and a storage medium storing the program so as to be readable by a computer.

2. Description of the Related Art

A method for operating a plurality of computers by a single input apparatus has been known in which the input apparatus is connected to the plurality of computers via wires, a switch is provided between the input apparatus and the plurality of computers, and connection between the input apparatus and the plurality of computers is physically switched by the switch. For example, a rotary switch is used as the switch, and the input apparatus is physically connected to one of the plurality of computers by switching the rotary switch.

Since a signal line from the input apparatus and signal lines from the plurality of computers are connected to the switch, the number of wires is large, resulting in difficulty in handling the wires.

Recently, input apparatuses using infrared rays or weak radio waves (hereinafter termed “wireless mice”) have appeared.

When performing one-to-one communication between a wireless mouse and the main body of a computer, in order to prevent cross talk in an environment in which a plurality of pairs of a wireless mouse and a computer are present as in an office, it is necessary to set a frequency channel for each of the pairs. However, which frequency is currently vacant without being used cannot be easily known, and therefore it is difficult set a frequency.

A description will now be provided of a conventional method for operating a plurality of computers by a single wireless mouse, with reference to FIG. 8.

A system shown in FIG. 8 includes two computers A 801 and B 802, and a wireless mouse 803 for selecting and operating one of the two computers A 801 and B 802.

A device number for identifying a computer is provided in advance for each of the computers A 801 and B 802. For example, device numbers “1” and “2” are set in the computers A 801 and B 802, respectively.

The user assigns the device number of a computer to be operated, through the wireless mouse 803. For example, when the user intends to operate the computer A 801, the device number “1” of the computer A 801 is assigned through the wireless mouse 803.

FIG. 9 is a diagram illustrating the format of data to be transmitted from the wireless mouse 803 to the computer A 801 or B 802. A number “1” indicating the device number of the computer A 801 is set as the number of the transmission destination, and the device number of the wireless mouse 803 is set as the number of the transmitter. Mouse data indicating the contents to be processed by the computer is also stored in the data. Check-sum data is added at the last of the data.

The computers A 801 and B 802 receive the data shown in FIG. 9 from the wireless mouse 803. When the number of the transmission destination stored in the received data is the device number “1” of the computer A 801, the computer A 801 performs processing in accordance with the contents shown in the mouse data. The computer B 802 abandons the received data because the device number of the computer B 802 is not “1”. The computers A 801 and B 802 check the number of the transmission destination in the same manner every time data is transmitted from the wireless mouse 803.

According to this method, a wireless mouse and all computers perform communication with the same frequency, and the wireless mouse is linked to a specific computer by assigning the device number of the concerned computer (i.e., by adding data).

However, the above-described conventional method still has the following problems.

First, the user must check the device number of each computer, and cannot easily select a specific device.

Furthermore, since the number of the transmission destination and the number of the transmitter are added to each of all data transmitted from the wireless mouse, the overhead of data is large. In addition, since a device number must be provided for data generated every time the click and the movement of the mouse are performed, the overhead of data is large.

In addition, all the computers must receive all data transmitted from the wireless mouse, and each of the computers must determine whether or not the number of the transmission destination corresponds to the number of the computer every time data has been received. Accordingly, even a computer which is not assigned as the transmission destination must receive all data transmitted from the wireless mouse and check the number of the transmission destination, thereby increasing the cost of processing.

Furthermore, a device number must be set for each computer by arranging such that the number is not overlapped, thereby requiring a troublesome operation.

### SUMMARY OF THE INVENTION

It is an object of the present invention to provide an input apparatus and device, a method for controlling the same, a program for executing the method, and a storage medium storing the program so as to be readable by a computer, in which the user can easily specify a device to be operated without increasing data processing, communication traffic and the like.

According to one aspect, the present invention which achieves the above-described object relates to an input apparatus connectable to a plurality of devices. The apparatus includes display means for displaying a list of the plurality of connected devices, selection means for selecting one of the plurality of devices based on the list displayed by the display means, and operation means for operating the device selected by the selection means.

According to another aspect, the present invention which achieves the above-described object relates to an input apparatus including connection means for performing radio connection to a plurality of devices, and operation means for operating one of the plurality of devices subjected to radio connection. The connection means performs radio connection to the device operated by the operation means and to other devices in different modes.

According to still another aspect, the present invention which achieves the above-described object relates to a communicatable device including connection means for performing radio connection to an input apparatus, and setting means for performing setting so as to be operated by the input apparatus. The connection means performs radio connection to the input apparatus in a mode corresponding to the setting by the setting means.

According to yet another aspect, the present invention which achieves the above-described object relates to a method for controlling an input apparatus connectable to a plurality of devices. The method includes a display step of displaying a list of the plurality of connected devices, a selection step of selecting one of the plurality of devices based on the list displayed in the display step, and an operation step of operating the device selected in the selection step.

According yet a further aspect, the present invention which achieves the above-described object relates to a method for controlling an input apparatus. The method includes a first connection step of performing radio connection to a plurality of devices, an operation step of operating one of the plurality of devices subjected to radio connection, and a second connection step of performing radio connection to the device operated in the operation step and to other devices in different modes.

According to still another aspect, the present invention which achieves the above-described object relates to a method for controlling a device. The method includes a connection step of performing radio connection to an input apparatus, a setting step of performing setting so as to be operated by the input apparatus, and a second connection step of performing radio connection to the input apparatus in a mode corresponding to the setting in the setting step.

According to still another aspect, the present invention which achieves the above-described object relates to a storage medium storing a program for controlling an input apparatus. The program includes a display step of displaying a list of a plurality of connected devices, a selection step of selecting one of the plurality of devices based on the list displayed in the display step, and an operation step of operating the device selected in the selection step.

According still another aspect, the present invention which achieves the above-described object relates to a storage medium storing a program for controlling an input apparatus. The program includes a connection step of performing radio connection to a plurality of devices, an operation step of operating one of the plurality of devices subjected to radio connection, and a second connection step of performing radio connection to the device operated in the operation step and to other devices in different modes.

According to still another aspect, the present invention which achieves the above-described object relates to a storage medium storing a program for controlling a device. The program includes a connection step of performing radio connection to an input apparatus, a setting step of performing setting so as to be operated by the input apparatus, and a second connection step of performing radio connection to the input apparatus in a mode corresponding to the setting in the setting step.

The foregoing and other objects, advantages and features of the present invention will become more apparent from the following description of the preferred embodiment taken in conjunction with the accompanying drawings.

### BRIEF DESCRIPTION OF THE DRAWINGS

FIG. 1 is a diagram illustrating the entire configuration of an input setting system according to an embodiment of the present invention;

FIG. 2 is a block diagram illustrating the configuration of a wireless mouse shown in FIG. 1;

FIG. 3 illustrates the configuration and a reading operation of an optical reading unit 209 provided within the wireless mouse;

FIG. 4 illustrates state transitions when establishing a piconet of Bluetooth communication between the wireless mouse and a peripheral device;

FIGS. 5A and 5B are flowcharts illustrating procedures for setting the wireless mouse of the embodiment as an input apparatus to peripheral devices;

FIGS. 6A and 6B are diagrams illustrating examples of device information relating to a multimedia-phone and device information relating to the wireless mouse, respectively, according to the embodiment;

FIG. 7 is a diagram illustrating a list of peripheral devices displayed on a display unit of the wireless mouse of the embodiment;

FIG. 8 is a diagram illustrating a conventional system including a wireless mouse;

FIG. 9 illustrates the format of data transmitted from the conventional wireless mouse; and

FIG. 10 illustrates flowcharts indicating a procedure for setting the wireless mouse of the embodiment as an input apparatus for a peripheral device in a sniff state.

### DESCRIPTION OF THE PREFERRED EMBODIMENT

A preferred embodiment of the present invention will now be described with reference to the drawings.

Nowadays, Network environments are being diffused not only in offices but also in homes.

Various types of connection are present, such as the ADSL (asymmetric digital subscriber line) using a telephone network, connection utilizing cables, connection utilizing optical fibers, and the like. In any type of connection, continuous connection is becoming adopted. In such an environment, it can be considered that information terminals different from terminals provided in offices tend to be provided in homes.

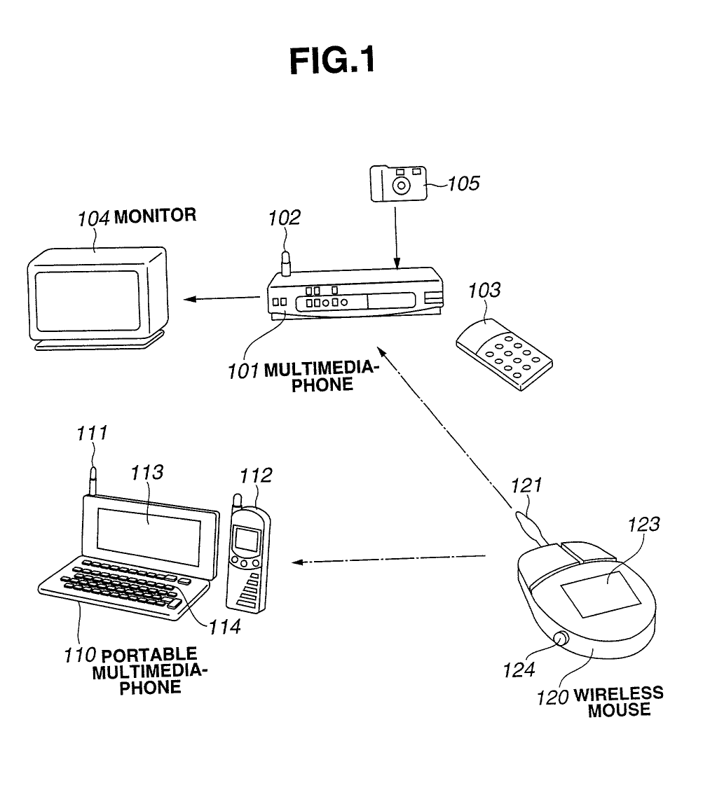

FIG. 1 is a diagram illustrating the entire configuration of an input setting system including an information terminal which is considered to be provided in a home.

In FIG. 1, reference numeral 101 represents an information terminal. In this embodiment, a case of using a multimedia-phone as the information terminal 101 will be described. The multimedia-phone 101 realizes the functions of a videophone, an IP (Internet protocol) telephone, a Web browser, an electronic mail, a still-image album, a music album, a moving-image album and the like without using a personal computer. The multimedia phone 101 realizes the filing function of storing still images, music, and moving images as a still-image album, a music album, and a moving-image album, respectively, input/output of images and sounds, and digital processing of digital sources.

A radio communication unit 102, a remote controller 103 for operating the multimedia-phone 101, a monitor (a display device, a television or the like) 104, serving as image output means, and a digital camera 105, serving as image input means, are provided as interfaces for realizing the above-described functions by the multimedia-phone 101. In this embodiment, the radio communication unit 102 is assumed to perform radio communication according to Bluetooth communication.

An interface to be connected to an access point using a radio LAN (local area network), and an interface comprising an ADSL or cable modem provided in the multimedia-phone 101 and having the function of being directly connected to an access point are provided as interfaces between the multimedia-phone 101 and an external network.

An IP-Web-phone 110 has an IP-telephone function, a Web-browsing function, and an electronic-mail function provided separately from the multimedia-phone 101. The IP-Web-phone 110 can be easily carried by the user and can be operated under the user's hand. Since the storage capacity of the IP-Web-phone is limited, the functions of the multimedia-phone 101 are utilized for storing a mail having at least a constant capacity and for filing. The IP-Web-phone 110 includes a radio communication unit 111 having a Bluetooth module, a telephone interface 112, a display unit 113, and a keyboard 114 for performing key input.

A wireless mouse 120 serves as an input apparatus for the multimedia-phone 101 or the IP-Web-phone 110 by utilizing a radio communication unit 121 having a Bluetooth module. A liquid-crystal display unit 123 is provided on an upper portion of the wireless mouse 120 in order to display a list of devices present near the wireless mouse 120. A mouse-function setting button 124 used when selecting a device displayed on the liquid-crystal display unit 123 is also provided in the wireless mouse 120. The mouse-function setting button 124 comprises a wheel. The user selects a device displayed on the liquid-crystal display unit 123 by rotating the wheel (the mouse-function setting button 124), and determines the selected device by depressing the wheel (the mouse-function setting button 124). Since the wireless mouse 120 is assumed to be used within a home, a non-contact-type optical sensor (not shown) is mounted therein so as be able to be used at any place without using a mouse pad.

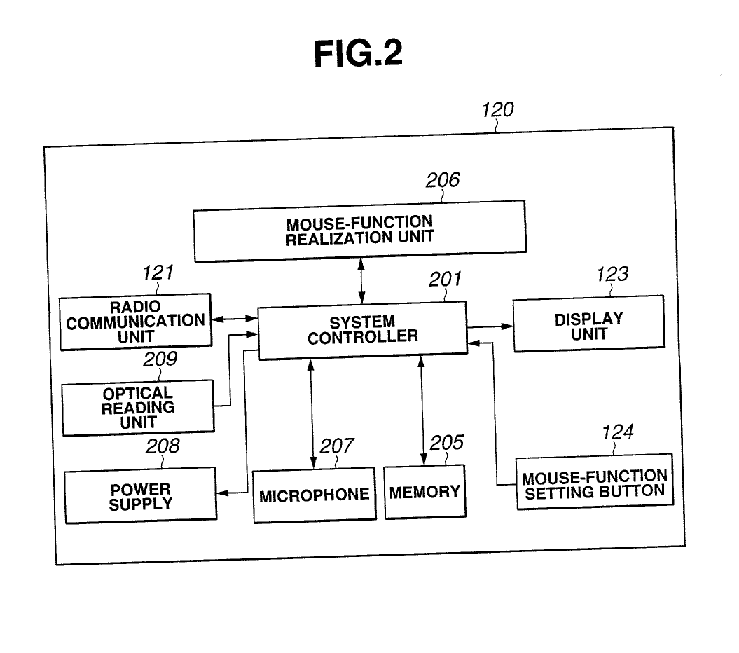

FIG. 2 is a block diagram illustrating the configuration of the wireless mouse 120.

The wireless mouse 120 includes a system controller 201, the radio communication unit 121 connected thereto, the display unit 123, the mouse-function setting button 124, a memory 205, a mouse-function realization unit 206, a microphone 207, a power supply 208, and an optical reading unit 209. The mouse-function realization unit 206 includes a click button and the like, and realizes the function of a pointing device for pointing an arbitrary portion on the picture surface of the monitor 104 or the like.

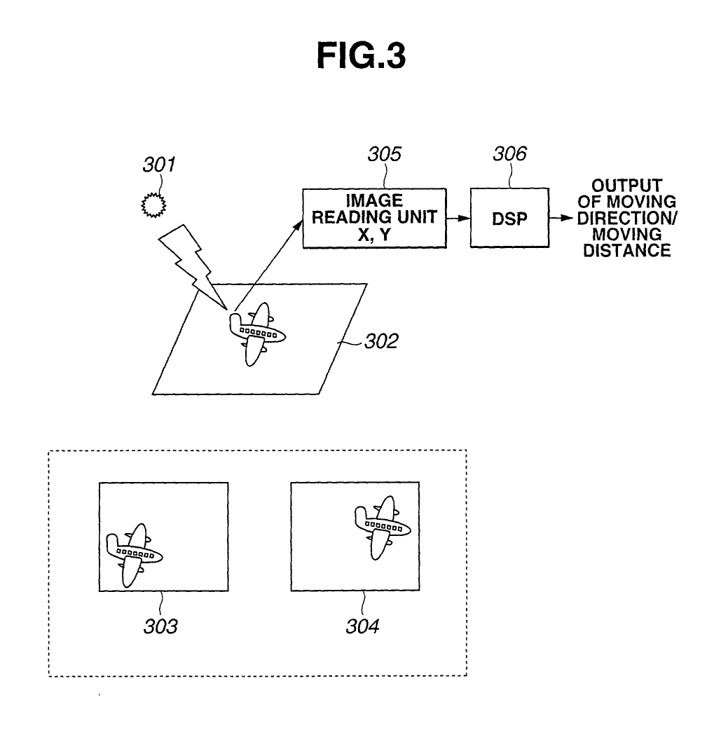

FIG. 3 illustrates the configuration and a reading operation of the optical reading unit 209 provided within the wireless mouse 120.

The optical reading unit 209 includes a high-brightness LED (light-emitting diode) 301, an image reading unit 305 and a DSP (digital signal processor) 306. The high-brightness LED 301 illuminates an image 302 by emitting light at a rate of 1,500 times per second. The image reading unit 305, comprising a photodetector or the like, receives reflected light in synchronization with the light emission, to read consecutive images 303 and 304.

The DSP 306 performs image correlation processing of converting changes of respective images into the movement of a mouse pointer on a screen for the read consecutive images 303 and 304, and calculates the moving direction and the moving distance. The calculated values correspond to the direction and the distance of the physical movement of the wireless mouse 120. Hence, the wireless mouse 120 does not require a particular mouse pad, and can calculate the moving direction and the moving distance of the mouse. Since the wireless mouse 120 incorporates the radio communication unit 121 and the non-contact-type optical sensor, it has large power consumption. Accordingly, the power supply 208 incorporates a charging unit, and can freely move to an energy-saving mode.

A procedure for operating peripheral devices (such as the multimedia-phone 101, the IP-Web-phone 110 and the like) using the wireless mouse 120 will now be described.

(Establishment of synchronization between the wireless mouse 120 and peripheral devices)

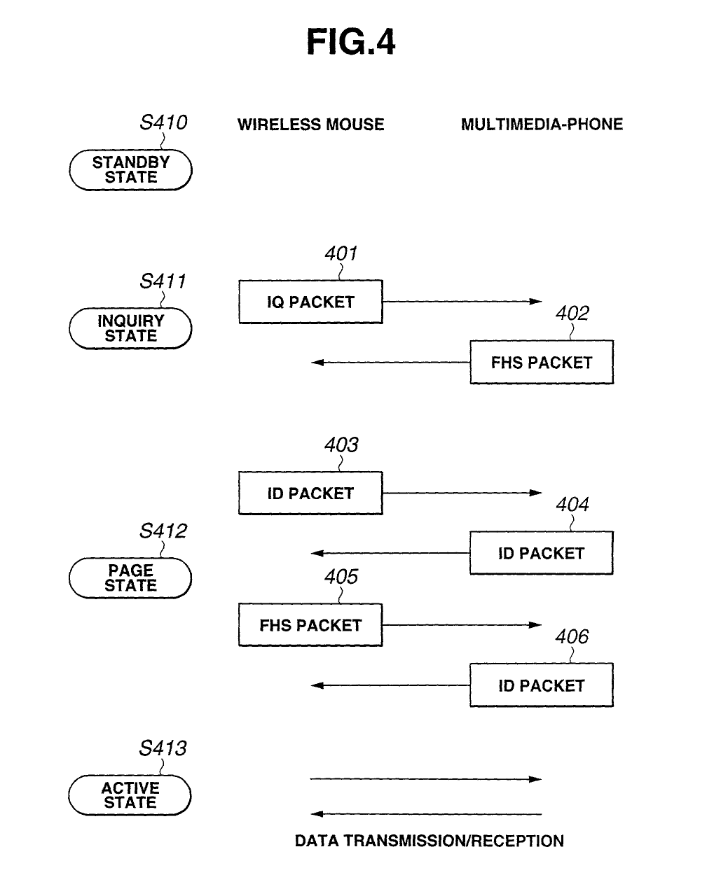

First, a description will be provided of a procedure for establishing synchronization in Bluetooth communication by the wireless mouse 120 and a peripheral device (the multimedia-phone 101), with reference to FIG. 4.

First, each of the wireless mouse 120 and the multimedia-phone 101 is in a standby state in which transmission/reception of any packet is not performed (step S410).

When the DSP 306 of the wireless mouse 120 detects that the mouse-function setting button 124 has been depressed, the radio communication unit 121 of the wireless mouse 120, serving as a master, continuously broadcasts an IP packet 401 in order to recognize a device (the multimedia-phone 101, the IP-Web-phone 110 or the like), serving as a slave, that is present near the wireless mouse 120 (an inquiry state: step S411). An IAC (inquiry access code) is used as an access code for the IQ packet 401 transmitted in the inquiry state. Although two types of IACs (a GIAC (general IAC) which is an access code shared by all devices, and a DIAC (dedicated IAC) which is an access code shared only within a specific group) are present, any one of the two access codes may be used.

The multimedia-phone 101 which has received the IQ packet from the wireless mouse 120 repeatedly transmits an FHS packet 402 for transmitting the attributes (the type of the device, a Bluetooth address, a Bluetooth clock signal, and the like) to the wireless mouse 120 (the inquiry state: step S411).

The wireless mouse 120 transmits an ID packet 403 to the multimedia-phone 101 based on information of the FHS packet 402 received in the inquiry state (a page state: step S412). The wireless mouse 120 transmits an ID packet based on the Bluetooth address of the multimedia-phone 101 included within the FHS packet 402.

The multimedia-phone 101 which has received the ID packet 403 from the wireless mouse 120 notifies confirmation of reception by transmitting an ID packet 404, which is the same as the received ID packet 403, to the wireless mouse 120 (the page state: step S412).

Then, in order to notify the Bluetooth address and the clock signal, the wireless mouse 120 transmits an FHS packet 405 to the multimedia-phone 101 (the page state: step S412).

The multimedia-phone 101 which has received the FHS packet 405 from the wireless mouse 120 performs confirmation of reception of the FHS packet 405 by transmitting an ID packet 406 to the wireless mouse 120 (the page state: step S412).

When the wireless mouse 120 is synchronized with the multimedia-phone 101 according to the above-described processing, a piconet is established, and an active state in which the wireless mouse 120 can communicate with the multimedia-phone 101 is provided. As for the IP-Web-phone 110 or each device (not shown), a piconet is established according to processing similar to the above-described processing for the multimedia-phone 101, and the active state (step S413) in which the concerned device can communicate with the wireless mouse 120 is provided.

(Communication connection between the wireless mouse 120 and a peripheral device)

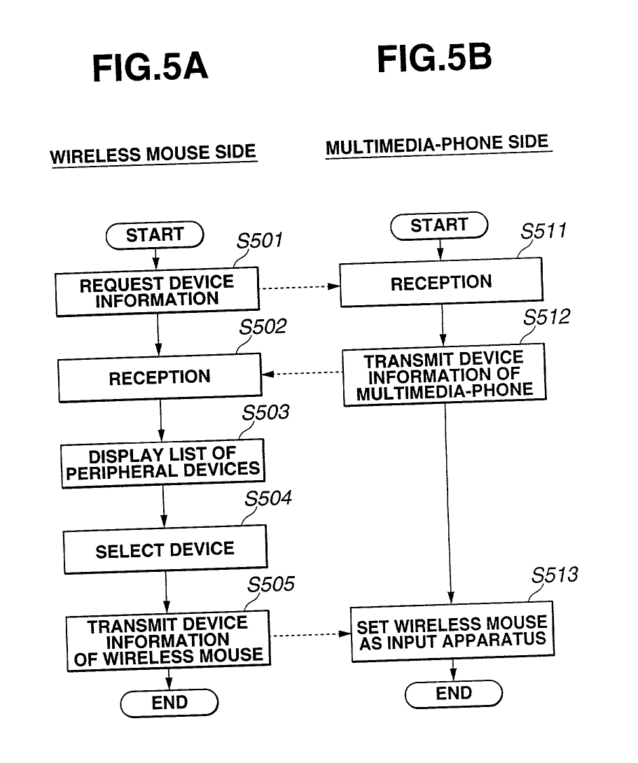

A description will now be provided of a procedure for setting the wireless mouse 120 as an input apparatus for a peripheral device, with reference to the flowcharts shown in FIGS. 5A and 5B.

The processing program shown in FIG. 5A is stored in a ROM (read-only memory, not shown) within the system controller 201 of the wireless mouse 120, and is executed by a CPU (central processing unit, not shown) within the system controller 201. The processing program shown in FIG. 5B is stored in a ROM (not shown) within the multimedia-phone 101, and is executed by a CPU (not shown) within the multimedia-phone 101.

When the active state has been provided in which the wireless mouse 120 can communicate with the peripheral devices, such as the multimedia-phone 101 and the like, in the above-described manner, the wireless mouse 120 request device information from the peripheral device (the multimedia-phone in this embodiment) (step S501).

Upon reception of the request for the device information from the wireless mouse 120, the multimedia-phone 101 transmits the device information relating to the multimedia-phone 101 to the wireless mouse 120 (step S512).

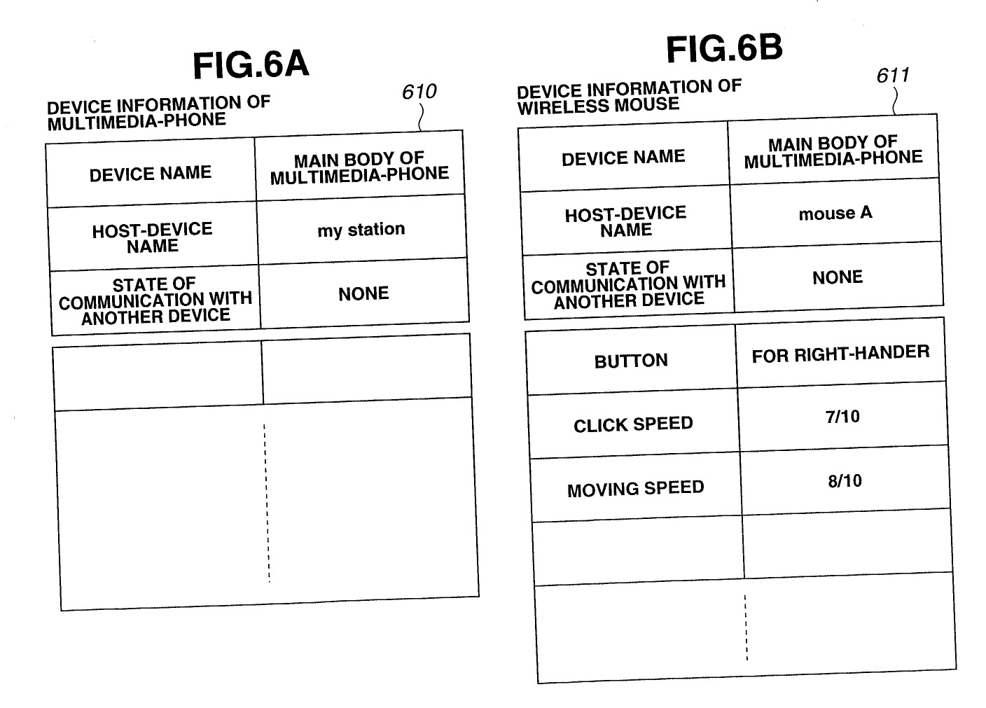

FIG. 6A shows an example of the device information of the multimedia-phone 101 to be transmitted to the wireless mouse 120 in step S512. The type of the device, such as the multimedia-phone, the IP Web phone or the like, is identified according to the device name. By providing the host-device name with a particular name, even a case in which a plurality of identical multimedia-phones are present can also be dealt with. Status information is also included in the device information, so that whether or not a state of communication with another device is currently present can be known.

When the wireless mouse 120 has received the device information from the multimedia-phone 101 (step S502), the system controller 201 of the wireless mouse 120 stores the received device information in the memory 205 of the wireless mouse 120. Similarly, device information is also received from other peripheral devices (the IP-Web-phone 110 and the like), and the received information is stored.

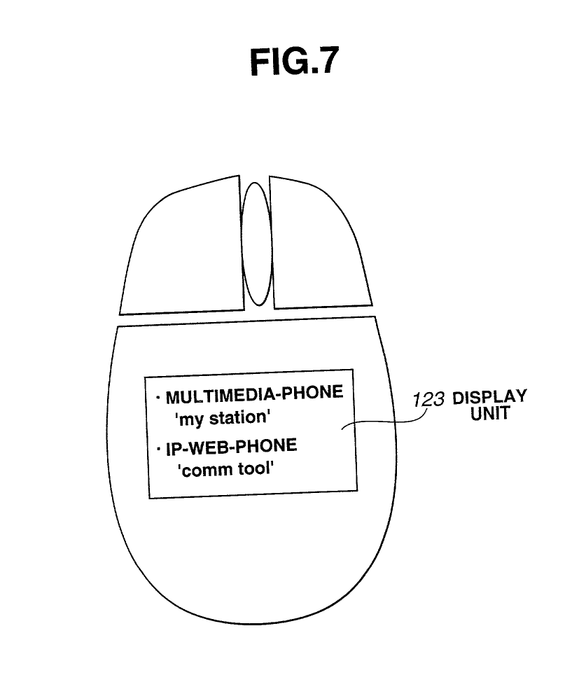

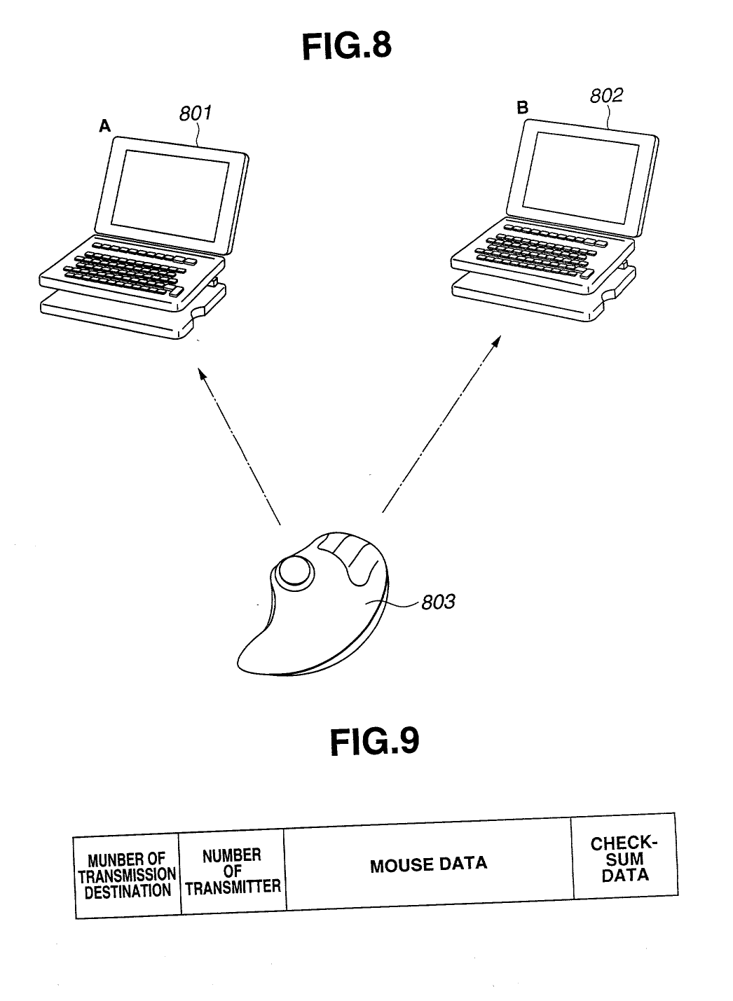

Based on the device information received in step S502, the list of the device name and the host-device name as shown in FIG. 7 is displayed on the display unit 123 (step S503). The user confirms the list displayed on the display unit 123 using the mouse-function setting button 124, selects a device to be operated (the multimedia-phone 101 in this embodiment), and determines the selected device by clicking the left button of the wireless mouse 120 (step S504).

The wireless mouse 120 transmits device information 611 of the wireless mouse 120 as shown in FIG. 6B to the multimedia-phone 101 determined in step S504 (step S505).

FIG. 6B illustrates the device information of the wireless mouse 120 transmitted to the multimedia-phone 101 in step S505. The device information 611 is stored in the memory 205 of the wireless mouse 120, and includes information peculiar to the wireless mouse 120, such as setting of the mouse button for a right-hander or a left-hander, the click speed, the design set of the mouse pointer, the moving speed of the mouse pointer, and the like. Initial values are set in the device information 611. The initial values can be changed by the user's intension. For example, while the wireless mouse 120 communicates with the multimedia-phone 101, a panel for setting the device information of the wireless mouse 120 is displayed on the monitor 104 of the multimedia-phone 101, and parameters, such as the click speed and the like, are set using the mouse-function setting button 124 depending on the user's intention. Upon completion of the setting, the multimedia-phone 101 transmits the changed device information to the wireless mouse 120, which stores the received new device information 611 of the wireless mouse 120 in the memory 205. Thus, it is unnecessary to perform setting of the wireless mouse 120 every time a device using the wireless mouse 120 as the input apparatus is changed.

Then, the multimedia-phone 101 receives the device information 611 of the wireless mouse 120, and stores setting values of the device information 611 of the wireless mouse 120 as values of the input device of the multimedia-phone 101. Thus, the wireless mouse 120 is set as the input apparatus for the multimedia-phone 110 (step S513).

A device which has not been selected in step S504 (the IP-Web-phone in this embodiment) shifts from the active state to a sniff state which is one of low-power-consumption states. The IP-Web-phone 110 in the sniff state is provided with a sniff slot from the wireless mouse 120 at every sniff period agreed with the wireless mouse 120. The wireless mouse 120 and the IP-Web-phone 110 transmit/receive a packet only during this sniff slot. Accordingly, since the wireless mouse 120 and the IP-Web-phone 110 perform minimum transmission/reception processing, power consumption can be reduced.

(Operation of peripheral devices by the wireless mouse 120)

The multimedia-phone 101 which has set the wireless mouse 120 as the input apparatus in the above-described manner starts, for example, videophone application software by an operation through the wireless mouse 120. In the videophone application software, when the communication partner of a videophone has been assigned from telephone-directory data registered in a memory (not shown) of the multimedia-phone 101, videophone communication is started, so that the user can utilize the videophone function of the multimedia-phone 101. The user performs videophone communication by operating the digital camera 105, serving as image output means, the monitor 104, serving as image output means, a speaker (not shown) incorporated in the monitor 104 as sound output means, and the microphone 207 incorporated in the wireless mouse 120 as sound input means, using the wireless mouse 120. The digital camera 105 and the monitor 104 are connected to the multimedia-phone 101 in advance.

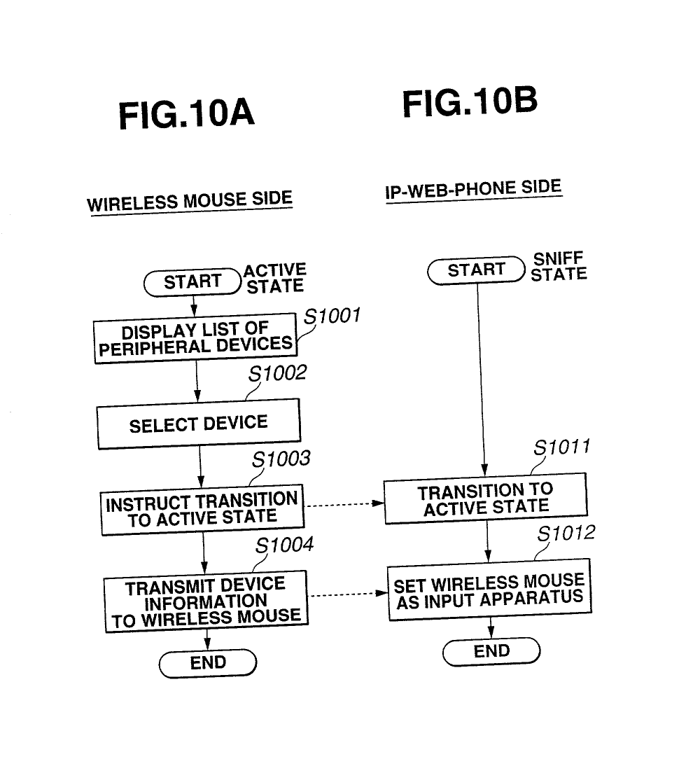

Next, a description will be provided of the operation of changing setting of the wireless mouse 120 from the input device for the multimedia-phone 101 to the input device for the IP-Web-phone 110, with reference to the flowchart shown in FIG. 10.

First, when the user depresses the mouse-function setting button 124 provided on the wireless mouse 120, the system controller 201 within the wireless mouse 120 displays the list of the device name and the host-device name as shown in FIG. 7 on the display unit 123, based on the device information stored in the memory 205 (step S1001).

The user confirms the list displayed on the display unit 123 using the wheel 122, selects a device to be operated (the IP-Web-phone 110 in this embodiment), and determines the selected device by clicking the left button of the wireless mouse 120 (step S1002).

The CPU within the wireless mouse 120 transmits a packet instructing transition to the active state to the IP-Web-phone 110 during the sniff slot set between the wireless mouse 120 and the IP-Web-phone 110 (step S1003).

The IP-Web-phone 110 which has received the instruction from the wireless mouse 120 shifts from the low-power-consumption sniff state to the active state (step S1011).

The IP-Web-phone 110 receives the device information 611 of the wireless mouse 120, and stores setting values of the device information of the wireless mouse 120 as values of the input apparatus for the IP-Web-phone 110. Thus, the wireless mouse 120 is set as the input device for the IP-Web-phone 110 (step S1012).

The user can operate the IP-Web-phone 110 using the set wireless mouse 120, and retrieve information using the Web browsing function of the IP-Web-phone 110.

At that time, since the multimedia-phone 101 is used as a videophone and maintains a state of connection to the communication partner, an operation using the wireless mouse 120 is unnecessary. Accordingly, the system controller 201 within the wireless mouse 120 shifts communication with the multimedia-phone 101 that is in the active state to the lower-power-consumption sniff state in order to reduce the load of communication processing.

Although in this embodiment, a description has been provided assuming that a peripheral device which does not set the wireless mouse 101 as the input apparatus is connected to the wireless mouse 101 in the sniff mode, the peripheral device may be connected in any other low-power-consumption mode, such as a hold mode, a park mode or the like.

The device to be operated by the wireless mouse 101 can be smoothly changed from the multimedia-phone 120 to the IP-Web-phone 110 in the above-described manner. Accordingly, even in a case in which information to be retrieved by the Web appears while the user communicates with the communication partner using the videophone function, and therefore the Web browsing function cannot be utilized because the videophone function is being used, it is to possible to change setting of the wireless mouse 120 as the input apparatus for the IP-Web-phone 110, and retrieve the desired information by utilizing the Web browsing function of the IP-Web-phone 110.

The preferred embodiment of the present invention has been described. However, the present invention is not limited to the configuration of the above-described embodiment, but may be applied to any other configuration, provided that the functions indicated in appended claims or the functions provided by the configuration of the embodiment are achieved.

For example, although in the above-described embodiment, the case of using a wireless mouse as an input apparatus has been illustrated, the present invention may also be applied to a case in which a tablet, a keyboard, or a pointing device, such as a track pad, a track ball or the like, is used as the input apparatus. Although in the above-described embodiment, a multimedia-phone or an IP-Web-phone has been illustrated as an information device to be operated, any other device, such as a digital camera or the like, may also be used as such a device.

The present invention may, of course, also be applied to a case in which the functions of the above-described embodiment are realized by supplying a system or an apparatus with program codes of software for realizing the functions of the embodiment that are stored in a storage medium. In such a case, the program codes themselves read from the storage medium realize the new functions of the present invention, and therefore the storage medium storing the program codes constitutes the present invention.

In the above-described embodiment, the program codes indicated in the flowchart shown in FIGS. 5A and 5B are stored in the ROM, serving as the storage medium. The storage medium is not limited to the ROM. For example, a floppy disk, a hard disk, an optical disk, a magnetooptical disk, a CD(compact disc)-ROM, a CD-R (recordable), a DVD (digital versatile disc), a magnetic tape, a nonvolatile memory card or the like may also be used as the storage medium.

As described above, in the present invention, a summary of devices which can be operated by an input apparatus is displayed on a display unit of the input apparatus. Thus, the user can easily select a device to be operated by the input apparatus from among the displayed devices.

As described above, in the present invention, radio connection of other devices that have not been selected by the user to the input apparatus is not disconnected, but is maintained in a low-power-consumption mode. Thus, only minimum transmission/reception processing is performed between the input apparatus and the other devices. Hence, it is possible to reduce power consumption and the amount of communication processing. Furthermore, since it is unnecessary to perform a procedure for newly setting radio connection when the device to be operated is changed, switching between devices can be smoothly performed.

The individual components shown in outline or designated by blocks in the drawings are all well known in the input apparatus and device arts and their specific construction and operation are not critical to the operation or the best mode for carrying out the invention.

While the present invention has been described with respect to what is presently considered to be the preferred embodiment, it is to be understood that the invention is not limited to the disclosed embodiment. To the contrary, the present invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An input apparatus connectable to a plurality of devices, said apparatus comprising:
display means for displaying a list of the plurality of connected devices;
selection means for selecting one of the plurality of devices based on the list displayed by said display means; and
operation means for operating the device selected by said selection means.

2. An apparatus according to claim 1, wherein the connection is performed according to radio communication conforming to Bluetooth standards.

3. An apparatus according to claim 1, wherein the connection is performed according to radio communication in different modes for the device operated by said operation means and other devices.

4. An apparatus according to claim 3, wherein the connection is performed in a communication connection mode for the device operated by said operation means, and the connection is performed in a low-power-consumption mode for the other devices.

5. An apparatus according to claim 4, wherein the low-power-consumption mode is one of a park mode, a hold mode and a sniff mode.

6. An apparatus according to claim 1, wherein said input apparatus comprises a pointing device.

7. An input apparatus comprising:
connection means for performing radio connection to a plurality of devices; and
operation means for operating one of the plurality of devices subjected to radio connection,
wherein said connection means performs radio connection to the device operated by said operation means and to other devices in different modes.

8. An apparatus according to claim 7, further comprising:
display means for displaying a list of the plurality of connected devices subjected to radio connection by said connection means; and
selection means for selecting the device to be operated by said operation means, based on the list displayed by said display means.

9. An apparatus according to claim 7, wherein the radio connection is performed in accordance with Bluetooth standards.

10. An apparatus according to claim 9, wherein said connection means performs the radio connection in a communication connection mode for the device operated by said operation means, and performs the radio connection in a low-power-consumption mode for the other devices.

11. An apparatus according to claim 10, wherein the low-power-consumption mode is one of a park mode, a hold mode and a sniff mode.

12. An apparatus according to claim 7, wherein said input apparatus comprises a pointing device.

13. A communicatable device comprising:
connection means for performing radio connection to an input apparatus; and
setting means for performing setting so as to be operated by said input apparatus,
wherein said connection means performs radio connection to the input apparatus in a mode corresponding to the setting by said setting means.

14. A device according to claim 13, wherein the radio connection is performed in accordance with Bluetooth standards.

15. A device according to claim 14, wherein said connection means performs the radio connection in a communication connection mode when the setting by said setting means is performed, and performs the radio connection in a low-power-consumption mode when the setting by said setting means is not performed.

16. A device according to claim 15, wherein the low-power-consumption mode is one of a park mode, a hold mode and a sniff mode.

17. A device according to claim 13, wherein said device is a multimedia-phone.

18. A method for controlling an input apparatus connectable to a plurality of devices, said method comprising:
a display step of displaying a list of the plurality of connected devices;
a selection step of selecting one of the plurality of devices based on the list displayed in said display step; and
an operation step of operating the device selected in said selection step.

19. A method for controlling an input apparatus, said method comprising:
a first connection step of performing radio connection to a plurality of devices;
an operation step of operating one of the plurality of devices subjected to radio connection; and
a second connection step of performing radio connection to the device operated in said operation step and to other devices in different modes.

20. A method for controlling a device, said method comprising:
a connection step of performing radio connection to an input apparatus;
a setting step of performing setting so as to be operated by said input apparatus; and
a second connection step of performing radio connection to the input apparatus in a mode corresponding to the setting in said setting step.

21. A storage medium storing a program for controlling an input apparatus, said program comprising:
a display step of displaying a list of a plurality of connected devices;
a selection step of selecting one of the plurality of devices based on the list displayed in said display step; and
an operation step of operating the device selected in said selection step.

22. A storage medium storing a program for controlling an input apparatus, said program comprising:
a connection step of performing radio connection to a plurality of devices;
an operation step of operating one of the plurality of devices subjected to radio connection; and
a second connection step of performing radio connection to the device operated in said operation step and to other devices in different modes.

23. A storage medium storing a program for controlling a device, said program comprising:
a connection step of performing radio connection to an input apparatus;
a setting step of performing setting so as to be operated by the input apparatus; and
a second connection step of performing radio connection to the input apparatus in a mode corresponding to the setting in said setting step.
